(19) United States
(12) Patent Application Publication
(10) Pub. No.: US 2004/0004709 A1
(43) Pub. Date: Jan. 8, 2004

(54) Method and system for performing measurements on an optical network

(76) Inventor: Donald Pitchforth JR., Rockwall, TX (US)

Correspondence Address: WORLDCOM, INC., Technology Law Department, 1133 19th Street, N.W., Washington, DC, 20036, US

(21) Appl. No.: 10/187,197

(22) Filed: Jul. 2, 2002

(51) Int. Cl. G01N 21/00

(52) U.S. Cl. 356/73.1

(57) ABSTRACT

An approach for performing measurements on an optical network is disclosed. A network management system is coupled to an optical channel (e.g., an Optical Service Channel (OSC)) that is designated to carry control information. The network management system monitors the optical network by examining transmission power of a signal carried over the optical network, and detects a change in the transmission power of the signal. A blanking circuit disables transmission of control information over an optical channel of the optical network. A test signal is transmitted over the optical channel and characteristics of a return signal corresponding to the test signal is captured, wherein the distance to a fault location along the optical network is determined based on characteristics of the return signal.

### FIELD OF THE INVENTION

The present invention generally relates to optical networks and more particularly to a method and system for performing measurements on an optical network.

### BACKGROUND OF THE INVENTION

In recent years, there has been an increase in bandwidth demands, leading network providers to move from conventional bandwidth constrained systems to fiber optic communications networks. Fiber optic communications networks provide higher capacity and reduced costs for bandwidth intensive applications, such as advanced digital services, high-speed Internet access, video on demand, interactive multimedia, etc., as compared to conventional networks. In addition, data transported in fiber optic communications networks is immune from electrical interference and does not radiate energy, thereby minimizing signal distortion and increasing security. Therefore, network providers have focused on deploying optical systems to address the bandwidth demands. Further, because fiber optical networks routinely carry mission critical data, issues of network availability, fault detection, and network restoration are of primary concern for these providers.

Fiber optic networks can be used in a range of environments, including local area networks (LANs), metropolitan area networks (MANs), and wide area networks (WANs), as well as Long Haul (LH) and Ultra Long Haul (ULH) environments. In a metropolitan environment, data travels within relatively short distances among nodes in the optical network. In the LH and ULH environments, optical networks typically can transport data over thousands of kilometers. Given their geographically broad coverage, LH and ULH networks can serve as backbone networks, for example, to connect major metropolitan areas. Because LH and ULH fiber optic networks provide backbone services, network availability and rapid fault detection and correction are of particular importance, as network outages affect a large user population.

As LH and ULH equipment is deployed into fiber optic communications networks, the ability to take routine measurements and determine faults in the network, such as cuts in the fiber, etc., becomes increasingly difficult in that network services need to be halted while the fault is diagnosed and network testing is performed. In this down period, the affected traffic may have to be diverted onto another fiber, while technicians then remove the fiber connection to perform testing. The test parameters may include channel power, channel center wavelength and spacing, signal-to-noise ratio, crosstalk, and total optical power.

Conventionally, a skilled technician is dispatched to make routine measurements and perform testing on the network using a measuring instrument known as an Optical Time Domain Reflectometer (OTDR). The OTDR takes optical measurements by transmitting a light pulse of a given wavelength down a fiber under test and analyzing the return signal due to scattering. By analyzing the characteristics of the return signal, the OTDR can determine locations of splices, connectors and cuts in the fiber under test, a well as measure the fiber attenuation as a function of distance.

From the above discussion, traditionally the approach to handling a network outage is to first determine the approximate location of a cut in fiber of a LH or ULH system, re-route traffic onto another fiber, and dispatch a technician. The technician travels to the local site where the cut is suspected and attaches the OTDR to the fiber for testing. After measurements are made, the connection needs to be manually re-established and traffic diverted back to its normal route.

With LH and ULH systems, however, rolling traffic onto another fiber may not be possible because of the tight tolerances for dispersion employed in such systems. Accordingly, any movement of such systems to other fibers runs a risk of introducing additional problems, such as re-calculation of a dispersion map. In addition, this procedure cannot remotely locate the source of the network outage, thereby requiring a manual process. Accordingly, the traditional testing procedure involving the use of an OTDR is very expensive in terms of manpower, time, and test equipment.

Therefore, there is a need to remotely perform tests on an optical network. There is also a need for cost-effectively providing fault detection and network restoration in an optical system.

### SUMMARY OF THE INVENTION

The above and other needs are addressed by the present invention, which provides an improved method and system for performing measurements on an optical network. According to one embodiment of the present invention, an optical channel of an optical network (e.g., Long Haul network and an Ultra Long Haul network) is employed to measure location of a fault in the optical network. In an exemplary embodiment, the optical channel is implemented as an optical service channel (OSC) and effects functionalities of an Optical Time Domain Reflectometer (OTDR). Under this approach, remote optical test and measurement functions can be performed with minimal addition of hardware and/or software, notably no addition lasers are required.

Accordingly, in one aspect of an embodiment of the present invention, a method for performing measurements on an optical network including an optical channel designated for transporting control information is disclosed. The method includes transmitting a test signal over the optical channel upon disabling transmission of the control information over the optical channel. The method also includes receiving a return signal associated with the test signal over the optical channel, wherein distance to a fault location along the optical network is determined based on characteristics of the return signal.

According to another aspect of an embodiment of the present invention, a system for performing measurements on an optical network is disclosed. The system includes a network management system coupled to an optical channel that is designated to carry control information. The network management system is configured to monitor the optical network by examining transmission power of a signal carried over the optical network, and to detect a change in the transmission power of the signal. The system also includes circuitry configured to disable transmission of the control information over an optical channel. A test signal is transmitted over the optical channel, and distance to a fault location along the optical network is determined based on characteristics of a return signal corresponding to the test signal.

According to another aspect of an embodiment of the present invention, a system for performing measurements on an optical network including an optical channel designated for transporting control information is disclosed. The system includes means for transmitting a test signal over the optical channel upon disabling transmission of the control information over the optical channel. The system also includes means for receiving a return signal associated with the test signal over the optical channel, wherein the distance to a fault location along the optical network is determined based on characteristics of the return signal.

According to another aspect of an embodiment of the present invention, a method for detecting fault in an optical network including an optical channel designated to transmit control information is disclosed. The method includes detecting a change in transmission power of a signal carried over the optical network, wherein the change is determined to correspond to a network fault, and initiating testing of the optical network to disable transmission of control information over an optical channel of the optical network. A test signal is transmitted over the optical channel and characteristics of a return signal corresponding to the test signal is captured.

In yet another aspect of an embodiment of the present invention, a computer-readable medium carrying one or more sequences of one or more instructions for detecting fault in an optical network including an optical channel designated to transmit control information is disclosed. The one or more sequences of one or more instructions include instructions which, when executed by one or more processors, cause the one or more processors to perform the steps of detecting a change in transmission power of a signal carried over the optical network, wherein the change is determined to correspond to a network fault, and initiating testing of the optical network to disable transmission of control information over an optical channel. A test signal is transmitted over the optical channel and characteristics of a return signal corresponding to the test signal is captured.

In another aspect of an embodiment of the present invention, system for performing measurements on an optical network. The system includes an optical service channel configured to transport control information over the optical network. The system also includes a network management system coupled the optical service channel and configured to monitor the optical network for a fault, wherein the location of the fault is determined by measuring distance to the fault using the optical channel.

Still other aspects, features, and advantages of the present invention are readily apparent from the following detailed description, simply by illustrating a number of particular embodiments and implementations, including the best mode contemplated for carrying out the present invention. The present invention is also capable of other and different embodiments, and its several details can be modified in various respects, all without departing from the spirit and scope of the present invention. Accordingly, the drawing and description are to be regarded as illustrative in nature, and not as restrictive.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 is a block diagram illustrating an exemplary optical network that can employ an optical channel for performing tests on fibers of the optical network;

FIG. 2 is a block diagram of a system capable of utilizing the optical channel for performing measurements of optical fibers in the system of FIG. 1;

FIG. 3 is a flow chart of the operation of the system of FIG. 2 for performing tests on fibers of the optical network; and

FIG. 4 is an exemplary computer system that can be programmed to perform one or more of the processes, in accordance with various embodiments of the present invention.

### DESCRIPTION OF THE PREFERRED EMBODIMENTS

A method and system for using an optical channel for performing tests on an optical network are described. In the following description, for purposes of explanation, numerous specific details are set forth in order to provide a thorough understanding of the present invention. It is apparent to one skilled in the art, however, that the present invention can be practiced without these specific details or with an equivalent arrangement. In some instances, well-known structures and devices are shown in block diagram form in order to avoid unnecessarily obscuring the present invention.

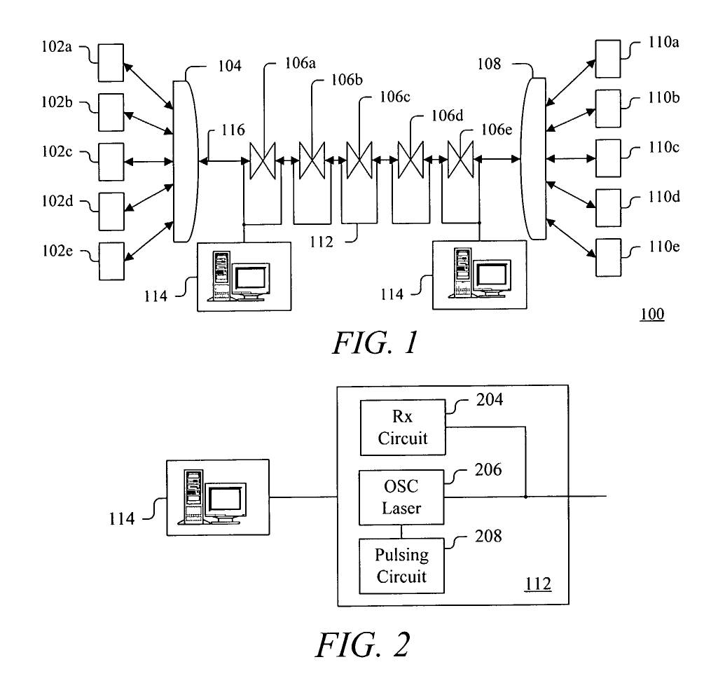

Referring now to the drawings, wherein like reference numerals designate identical or corresponding parts throughout the several views, and more particularly to FIG. 1 thereof, there is illustrated an exemplary optical network system 100 that can employ an optical channel to perform testing on fibers of the optical network, according to the present invention. In FIG. 1, the system 100 includes, for example, an optical amplifier 106a-106e chain that is terminated with network elements 102a-102e and 110a-110e, multiplexer/de-multiplexer (MUX/DEMUX) modules 104 and 108, such as add/drop multiplexers (ADMs), an optical channel 112 for carrying control and signaling information, one or more Network Management Centers (NMCs) 114, and an optical fiber 116.

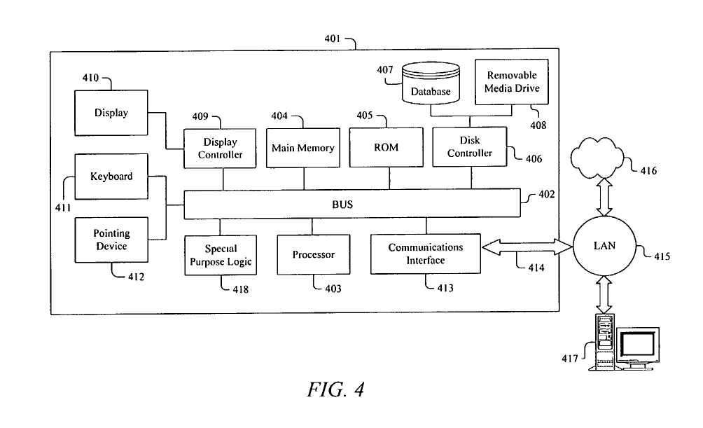

The architecture of FIG. 1 is of an exemplary nature and the present invention is applicable to other optical networks employing optical channels, as will be appreciated by those skilled in the relevant art(s). The system 100 can include any suitable servers, workstations, personal computers (PCs), other devices, etc., capable of performing the processes of the present invention. One or more of the devices shown in FIG. 1 can be implemented using the computer system 401 of FIG. 4, for example. One or more interface mechanisms can be used in the system 100, for example, including Internet access, intranet access, etc.

The system 100 of FIG. 1 may be part of a Dense Wavelenghth Division Multiplexed (DWDM) system, wherein the optical fiber 116 carries multiple optical channels at predetermined wavelengths (λ₁ . . . λₙ). As seen in FIG. 1, the optical channel 112 terminates at each of the amplifiers 106a-106e and can carry control and management traffic. According to an embodiment of the present invention, the optical channel 112 is implemented as an Optical Service Channel (OSC), which has a predetermined wavelength (λ_{osc}, e.g., 1510 nm).

The system 100 of FIG. 1 can be employed in Long Haul (LH) and Ultra Long Haul (ULH) environments as a backbone network, for example, to connect the network elements 102a-102e (e.g., optical gateways) of one major metropolitan area to the network elements 110a-110e (e.g., optical gateways) of another major metropolitan area. The optical channel 112 (in the case of being implemented as an OSC) is utilized by a Network Management System (NMS) 114, in an exemplary embodiment, to support operations access to amplifiers 106a-106e and network management functions, including, for example, alarm reporting, end-to-end provisioning, optical layer fault management, optical layer maintenance tools, software downloads, etc.

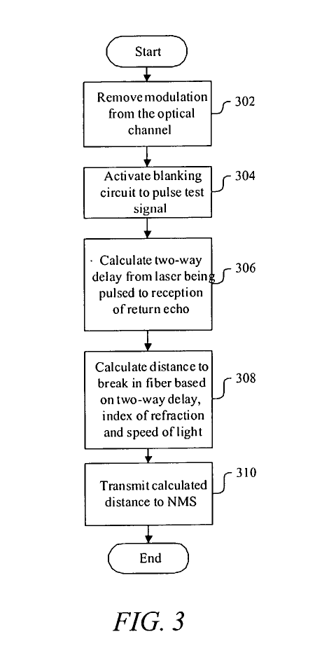

According to an embodiment of the present invention, the optical channel 112 has two modes of operation: test mode, and normal mode. Under the normal mode, the optical channel 112 transports control and management traffic, as described above. In the test mode, the optical channel 112 is employed to conduct remote testing of the optical fiber 116. Testing can include, for example, determining locations of splices, connectors and cuts in the fiber 116, measuring the fiber 116 attenuation as a function of distance, etc. The process of remote testing via the optical channel 112 is more fully described below with respect to FIGS. 2 and 3. Under the test mode, the optical channel 112 effectively permits measurement of a fiber's length, end-to-end loss, location, optical loss, and reflectivity of network components, effectively providing the functionality of an Optical Time Domain Reflectometer (OTDR).

Therefore, tests on the optical fiber 116 of the system 100 can be performed remotely and in a time-efficient manner because the tests and repairs can be performed while the optical fiber 116 remains in place in the system 100, thereby obviating a need to roll traffic onto another fiber. This is not possible with the manual OTDR approach, because an end of the fiber 116 would have to be removed from the system 100 in order to perform testing. In addition, due to the remote test capability provided by the system 100, advantageously, technicians do not have to be dispatched to the potentially failed site to perform testing. Accordingly, the system 100 provides a cost-effective approach for performing tests on optical fibers, in terms of manpower, time, and test equipment.

It is to be understood that the system in FIG. 1 is for exemplary purposes only, as many variations of the specific hardware and/or software used to implement the present invention are possible, as will be appreciated by those skilled in the relevant art(s). For example, the functionality of one or more of the devices of the system 100 can be implemented via one or more programmed computer systems or devices. To implement such variations as well as other variations, a single computer (e.g., the computer system 401 of FIG. 4) can be programmed to perform the special purpose functions of one or more of the devices of the system 100 of FIG. 1.

Alternatively, two or more programmed computer systems or devices, for example as in shown FIG. 4, may be substituted for any one of the devices of the system 100 of FIG. 1. Principles and advantages of distributed processing, such as redundancy, replication, etc., can also be implemented as desired to increase the robustness and performance of the system 100, for example.

FIG. 2 is a block diagram of a system capable of utilizing the optical channel for performing measurements of optical fibers in the system of FIG. 1. As shown, an optical laser (e.g., a 1510 nm laser) within a Transmit (Tx) circuit 206 is coupled to the optical channel 112 by a blanking circuit 208, which is configured to temporarily remove the modulation from the optical channel 112 and to send a test signal, thereby halting control and management information traffic. A receive (Rx) circuit 204 detects the return signal resulting from the transmitted test signal (i.e., pulse). Under this arrangement, the optical channel 112 can perform OTDR functionality, remotely, via OTDR logic 210. In an exemplary embodiment, the circuitry 204, 206, 208 and OTDR logic 210 are implemented at each of the amplifier sites 106a-106e.

In operation, signals between transmitters and receivers (e.g., the network elements 102a-102e and 110a-110e) can be monitored to detect any changes in a level of a receive signal, where no change in transmit power is detected. This is then reported as a change in path attenuation. When communication between a transmitter (Tx) and receiver (Rx) is lost, as in the case of a cut in the fiber 116, the system 100 is placed in the test mode.

In the test mode, the transmission of control and management traffic ceases; specifically, modulation (e.g., light pulses modulated on the optical channel 112 based data transported thereon) on the optical channel 112 is temporarily disabled and the blanking circuit 208 is then activated. A test signal, or pulse, is sent out by the laser 206 on command from the blanking circuit 208. The resulting reflections of the test signal are received via the Rx circuit 204, and the reflection characteristics are analyzed by the OTDR logic 210. Thereafter, data is sent to the NMS 114.

Optical network hardware can include the circuitry 204 and 208 as part of the optical channel 112, and allow removal of modulation from the optical channel 112 at a request of the NMS 114 or when a cut in the fiber 116 is suspected. Advantageously, the disruption due to fault location determination would only occur in the section of the system 100 that is affected by a cut in the fiber 116 and would not affect any communications between active components that are not affected by the cut. By contrast, with the traditional manual OTDR approach, disruption due to the manual OTDR testing would affect all traffic on the optical system, as an end of the fiber would have to be disconnected from the system to perform testing.

As previously noted, the traditional approach is to employ an external OTDR on the fiber under test and move any traffic carrying systems to another fiber. With LH and ULH systems, however, this may not be possible because of tight tolerances for dispersion employed in such systems. Accordingly, any movement of such systems to other fibers could require a recalculation of a dispersion map. In addition, with conventional techniques, a technician must be sent to a site where a fiber cut is suspected and the technician must manually perform OTDR testing to determine where the fiber cut may be located.

By effectively employing OTDR functionality within the optical channel 112 via the ODTR logic 210, the traditional OTDR procedures are eliminated and automated, in that such functionality can be conducted remotely. Testing via the optical channel 112 thus reduces discovery time for fiber cuts as well as restoration time. Further, when the optical channel 112 is implemented as an Optical Service Channel (OSC), the lasers 206 are already installed to support OSC functions, thus no additional lasers are needed, thereby lowering testing costs over the traditional approach involving the use of technicians and external OTDR test equipment.

FIG. 3 is a flow chart for illustrating the operation of the optical channel 112 of FIG. 2 to provide remote fault detection. For the purposes of explanation, it is assumed that the system 100 is operating in a normal state and control and management is carried by the optical channel 112, and then, a fiber cut occurs in one of the sections of the fiber 116 of the system 100. A loss of signal is detected on the receiving amplifiers in both directions. The modulation (e.g., light pulses modulated on the optical channel 112 based data transported thereon) is removed from the optical channel 112 (step 302). The blanking circuit 208 is enabled on the optical channel 112 and the laser 206 is pulsed at a predetermined rate (step 304).

A two-way delay Δt from a pulse transmission to a receipt of a return signal at the Rx circuit 204 is calculated by the ODTR logic 210 (step 306). The ODTR logic 210 also calculates, per step 308, the distance L to the cut in the fiber 116 based on the following equation:

L=(Δt·c)/2n,

where c is the speed of light, and n is the index of refraction for the type of the fiber 116 employed. The information on the distance L to the cut in the fiber 116 is transmitted to the NMS 114 (step 310), for example, via an e-mail message, a Transaction Language 1 (TL1) alarm message, a pager message, etc., completing the remote OTDR operation via the optical channel 112.

In an alternative embodiment, the NMS 114 can be configured to perform the steps 306-308 of the above process, as will be appreciated by those skilled in the relevant art(s). In addition, the ODTR logic 210 and/or the NMS 114 can be configured to analyze characteristics of the return signal to determine locations of splices, connectors, and cuts in the fiber 116, as well as measure attenuation of the fiber 116 as a function of distance.

According to one embodiment, the present invention stores information relating to various processes described herein. This information is stored in one or more memories, such as a hard disk, optical disk, magneto-optical disk, RAM, etc. One or more databases, such as databases within the devices of the system 100 of FIG. 1 can store the information used to implement the present invention. The databases are organized using data structures (e.g., records, tables, arrays, fields, graphs, trees, and/or lists) contained in one or more memories, such as the memories listed above or any of the storage devices listed below in the discussion of FIG. 4, for example.

The previously described processes include appropriate data structures for storing data collected and/or generated by the processes of the system 100 of FIG. 1 in one or more databases thereof. Such data structures accordingly can includes fields for storing such collected and/or generated data. In a database management system, data is stored in one or more data containers, each container contains records, and the data within each record is organized into one or more fields. In relational database systems, the data containers are referred to as tables, the records are referred to as rows, and the fields are referred to as columns. In object-oriented databases, the data containers are referred to as object classes, the records are referred to as objects, and the fields are referred to as attributes. Other database architectures can use other terminology. Systems that implement the present invention are not limited to any particular type of data container or database architecture. However, for the purpose of explanation, the terminology and examples used herein shall be that typically associated with relational databases. Thus, the terms “table,” “row,” and “column” shall be used herein to refer respectively to the data container, record, and field.

The present invention (e.g., as described with respect to FIGS. 1-3) can be implemented by the preparation of application-specific integrated circuits or by interconnecting an appropriate network of component circuits, as will be appreciated by those skilled in the electrical art(s). In addition, all or a portion of the invention (e.g., as described with respect to FIGS. 1-3) can be implemented using one or more general purpose computer systems, microprocessors, digital signal processors, micro-controllers, etc., programmed according to the teachings of the present invention (e.g., using the computer system 401 of FIG. 4), as will be appreciated by those skilled in the computer and software art(s). Appropriate software can be readily prepared by programmers of ordinary skill based on the teachings of the present disclosure, as will be appreciated by those skilled in the software art. Further, the present invention can be implemented on the World Wide Web (e.g., using the computer system 401 of FIG. 4).

FIG. 4 shows an exemplary computer system that can be programmed to perform one or more of the processes, in accordance with various embodiments of the present invention. The present invention can be implemented on a single such computer system, or a collection of multiple such computer systems. The computer system 401 includes a bus 402 or other communication mechanism for communicating information, and a processor 403 coupled to the bus 402 for processing the information. The computer system 401 also includes a main memory 404, such as a random access memory (RAM), other dynamic storage device (e.g., dynamic RAM (DRAM), static RAM (SRAM), synchronous DRAM (SDRAM)), etc., coupled to the bus 402 for storing information and instructions to be executed by the processor 403. In addition, the main memory 404 can also be used for storing temporary variables or other intermediate information during the execution of instructions by the processor 403. The computer system 401 further includes a read only memory (ROM) 405 or other static storage device (e.g., programmable ROM (PROM), erasable PROM (EPROM), electrically erasable PROM (EEPROM), etc.) coupled to the bus 402 for storing static information and instructions.

The computer system 401 also includes a disk controller 406 coupled to the bus 402 to control one or more storage devices for storing information and instructions, such as a magnetic hard disk 407, and a removable media drive 408 (e.g., floppy disk drive, read-only compact disc drive, read/write compact disc drive, compact disc jukebox, tape drive, and removable magneto-optical drive). Such storage devices can be added to the computer system 401 using an appropriate device interface (e.g., small computer system interface (SCSI), integrated device electronics (IDE), enhanced-IDE (E-IDE), direct memory access (DMA), or ultra-DMA).

The computer system 401 can also include special purpose logic devices 418, such as application specific integrated circuits (ASICs), full custom chips, configurable logic devices (e.g., simple programmable logic devices (SPLDs), complex programmable logic devices (CPLDs), field programmable gate arrays (FPGAs), etc.), etc., for performing special processing functions, such as signal processing, image processing, speech processing, voice recognition, infrared (IR) data communications, blanking circuit 208 functions, Rx circuit 204 functions, etc.

The computer system 401 can also include a display controller 409 coupled to the bus 402 to control a display 410, such as a cathode ray tube (CRT), liquid crystal display (LCD), active matrix display, plasma display, touch display, etc., for displaying or conveying information to a computer user. The computer system includes input devices, such as a keyboard 411 including alphanumeric and other keys and a pointing device 412, for interacting with a computer user and providing information to the processor 403. The pointing device 412, for example, can be a mouse, a trackball, a pointing stick, etc., or voice recognition processor, etc., for communicating direction information and command selections to the processor 403 and for controlling cursor movement on the display 410. In addition, a printer can provide printed listings of the data structures/information of the system shown in FIG. 1, or any other data stored and/or generated by the computer system 401.

The computer system 401 performs a portion or all of the processing steps of the invention in response to the processor 403 executing one or more sequences of one or more instructions contained in a memory, such as the main memory 404. Such instructions can be read into the main memory 404 from another computer readable medium, such as a hard disk 407 or a removable media drive 408. Execution of the arrangement of instructions contained in the main memory 404 causes the processor 403 to perform the process steps described herein. One or more processors in a multi-processing arrangement can also be employed to execute the sequences of instructions contained in main memory 404. In alternative embodiments, hardwired circuitry can be used in place of or in combination with software instructions. Thus, embodiments are not limited to any specific combination of hardware circuitry and software.

Stored on any one or on a combination of computer readable media, the present invention includes software for controlling the computer system 401, for driving a device or devices for implementing the invention, and for enabling the computer system 401 to interact with a human user (e.g., users of the system 100 of FIG. 1, etc.). Such software can include, but is not limited to, device drivers, operating systems, development tools, and applications software. Such computer readable media further includes the computer program product of the present invention for performing all or a portion (if processing is distributed) of the processing performed in implementing the invention. Computer code devices of the present invention can be any interpretable or executable code mechanism, including but not limited to scripts, interpretable programs, dynamic link libraries (DLLs), Java classes and applets, complete executable programs, Common Object Request Broker Architecture (CORBA) objects, etc. Moreover, parts of the processing of the present invention can be distributed for better performance, reliability, and/or cost.

The computer system 401 also includes a communication interface 413 coupled to the bus 402. The communication interface 413 provides a two-way data communication coupling to a network link 414 that is connected to, for example, a local area network (LAN) 415, or to another communications network 416 such as the Internet. For example, the communication interface 413 can be a digital subscriber line (DSL) card or modem, an integrated services digital network (ISDN) card, a cable modem, a telephone modem, etc., to provide a data communication connection to a corresponding type of telephone line. As another example, communication interface 413 can be a local area network (LAN) card (e.g., for Ethernet™, an Asynchronous Transfer Model (ATM) network, etc.), etc., to provide a data communication connection to a compatible LAN. Wireless links can also be implemented. In any such implementation, communication interface 413 sends and receives electrical, electromagnetic, or optical signals that carry digital data streams representing various types of information. Further, the communication interface 413 can include peripheral interface devices, such as a Universal Serial Bus (USB) interface, a PCMCIA (Personal Computer Memory Card International Association) interface, etc.

The network link 414 typically provides data communication through one or more networks to other data devices. For example, the network link 414 can provide a connection through local area network (LAN) 415 to a host computer 417, which has connectivity to a network 416 (e.g. a wide area network (WAN) or the global packet data communication network now commonly referred to as the “Internet”) or to data equipment operated by service provider. The local network 415 and network 416 both use electrical, electromagnetic, or optical signals to convey information and instructions. The signals through the various networks and the signals on network link 414 and through communication interface 413, which communicate digital data with computer system 401, are exemplary forms of carrier waves bearing the information and instructions.

The computer system 401 can send messages and receive data, including program code, through the network(s), network link 414, and communication interface 413. In the Internet example, a server (not shown) might transmit requested code belonging to an application program for implementing an embodiment of the present invention through the network 416, LAN 415 and communication interface 413. The processor 403 can execute the transmitted code while being received and/or store the code in storage devices 407 or 408, or other non-volatile storage for later execution. In this manner, computer system 401 can obtain application code in the form of a carrier wave. With the system of FIG. 4, the present invention can be implemented on the Internet as a Web Server 401 performing one or more of the processes according to the present invention for one or more computers coupled to the Web server 401 through the network 416 coupled to the network link 414.

The term “computer readable medium” as used herein refers to any medium that participates in providing instructions to the processor 403 for execution. Such a medium can take many forms, including but not limited to, non-volatile media, volatile media, transmission media, etc. Non-volatile media include, for example, optical or magnetic disks, magneto-optical disks, etc., such as the hard disk 407 or the removable media drive 408. Volatile media include dynamic memory, etc., such as the main memory 404. Transmission media include coaxial cables, copper wire, fiber optics, including the wires that make up the bus 402. Transmission media can also take the form of acoustic, optical, or electromagnetic waves, such as those generated during radio frequency (RF) and infrared (IR) data communications. As stated above, the computer system 401 includes at least one computer readable medium or memory for holding instructions programmed according to the teachings of the invention and for containing data structures, tables, records, or other data described herein. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, and EPROM, a FLASH-EPROM, any other memory chip or cartridge, a carrier wave, or any other medium from which a computer can read.

Various forms of computer-readable media can be involved in providing instructions to a processor for execution. For example, the instructions for carrying out at least part of the present invention can initially be borne on a magnetic disk of a remote computer connected to either of networks 415 and 416. In such a scenario, the remote computer loads the instructions into main memory and sends the instructions, for example, over a telephone line using a modem. A modem of a local computer system receives the data on the telephone line and uses an infrared transmitter to convert the data to an infrared signal and transmit the infrared signal to a portable computing device, such as a personal digital assistant (PDA), a laptop, an Internet appliance, etc. An infrared detector on the portable computing device receives the information and instructions borne by the infrared signal and places the data on a bus. The bus conveys the data to main memory, from which a processor retrieves and executes the instructions. The instructions received by main memory can optionally be stored on storage device either before or after execution by processor.

By employing the existing laser 206 of the optical channel 112 and the additional circuitry 204 and 206, advantageously, on-board OTDR functionality can be provided within the optical channel 112. Accordingly, the system 100 can perform fiber cut detection, loss detection, etc. The system 100 can aid communications service providers in deploying systems because the present invention alleviates the issue of not being able to do remote fiber maintenance on LH and ULH systems. The present invention, advantageously, can be employed in domestic and international fiber optic communications systems.

While the present invention has been described in connection with a number of embodiments and implementations, the present invention is not so limited, but rather covers various modifications and equivalent arrangements, which fall within the purview of the appended claims.

What is claimed is:

1. A method for performing measurements on an optical network including an optical channel designated for transporting control information, the method comprising:
transmitting a test signal over the optical channel upon disabling transmission of the control information over the optical channel; and
receiving a return signal associated with the test signal over the optical channel, wherein distance to a fault location along the optical network is determined based on characteristics of the return signal.

2. A method according to claim 1, wherein the characteristics include delay from the transmission of the test signal until the receipt of the return signal, and an index of refraction of an optical fiber corresponding to the optical channel.

3. A method according to claim 1, wherein the optical network includes at least one of a Long Haul network and an Ultra Long Haul network.

4. A method according to claim 1, further comprising:
monitoring the optical network by examining transmission power of a signal carried over the optical network; and
detecting a change in the transmission power of the signal, wherein the transmission of the control information is disabled in response to the changed signal level.

5. A method according to claim 1, wherein the characteristics include reflectivity.

6. A method according to claim 1, further comprising:
forwarding the determined distance to a network management system in communication with the optical network.

7. A system for performing measurements on an optical network, the system comprising:
a network management system coupled to an optical channel that is designated to carry control information, the network management system being configured to monitor the optical network by examining transmission power of a signal carried over the optical network, and to detect a change in the transmission power of the signal; and
circuitry configured to disable transmission of the control information over the optical channel, wherein a test signal is transmitted over the optical channel, and distance to a fault location along the optical network is determined based on characteristics of a return signal corresponding to the test signal.

8. A system according to claim 7, wherein the characteristics include delay from the transmission of the test signal until the receipt of the return signal, and an index of refraction of an optical fiber corresponding to the optical channel.

9. A system according to claim 7, wherein the optical network includes at least one of a Long Haul network and an Ultra Long Haul network.

10. A system according to claim 7, wherein the characteristics include reflectivity.

11. A system for performing measurements on an optical network including an optical channel designated for transporting control information, the system comprising:
means for transmitting a test signal over the optical channel upon disabling transmission of the control information over the optical channel; and
means for receiving a return signal associated with the test signal over the optical channel, wherein distance to a fault location along the optical network is determined based on characteristics of the return signal.

12. A system according to claim 11, wherein the characteristics include delay from the transmission of the test signal until the receipt of the return signal, and an index of refraction of an optical fiber corresponding to the optical channel.

13. A system according to claim 11, wherein the optical network includes at least one of a Long Haul network and an Ultra Long Haul network.

14. A system according to claim 11, further comprising:
means for monitoring the optical network by examining transmission power of a signal carried over the optical network; and
means for detecting a change in the transmission power of the signal, wherein the transmission of the control information is disabled in response to the changed signal level.

15. A system according to claim 11, wherein the characteristics include reflectivity.

16. A method for detecting fault in an optical network including an optical channel designated to transmit control information, the method comprising:
detecting a change in transmission power of a signal carried over the optical network, wherein the change is determined to correspond to a network fault; and
initiating testing of the optical network to disable transmission of control information over an optical channel, wherein a test signal is transmitted over the optical channel and characteristics of a return signal corresponding to the test signal is captured.

17. A method according to claim 16, further comprising:
receiving information specifying the characteristics of the return signal; and
determining distance to a fault location along the optical network based on the characteristics of the return signal.

18. A method according to claim 16, wherein the characteristics include delay from the transmission of the test signal until the receipt of the return signal, and an index of refraction of an optical fiber corresponding to the optical channel.

19. A method according to claim 16, wherein the optical network includes at least one of a Long Haul network and an Ultra Long Haul network.

20. A method according to claim 16, wherein the characteristics include reflectivity.

21. A computer-readable medium carrying one or more sequences of one or more instructions for detecting fault in an optical network including an optical channel designated to transmit control information, the one or more sequences of one or more instructions including instructions which, when executed by one or more processors, cause the one or more processors to perform the steps of:
detecting a change in transmission power of a signal carried over the optical network, wherein the change is determined to correspond to a network fault; and
initiating testing of the optical network to disable transmission of control information over an optical channel, wherein a test signal is transmitted over the optical channel and characteristics of a return signal corresponding to the test signal is captured.

22. A computer-readable medium according to claim 21, wherein the one or more processors further perform the steps of:
receiving information specifying the characteristics of the return signal; and
determining distance to a fault location along the optical network based on the characteristics of the return signal.

23. A computer-readable medium according to claim 21, wherein the characteristics include delay from the transmission of the test signal until the receipt of the return signal, and an index of refraction of an optical fiber corresponding to the optical channel.

24. A computer-readable medium according to claim 21, wherein the optical network includes at least one of a Long Haul network and an Ultra Long Haul network.

25. A computer-readable medium according to claim 21, wherein the characteristics include reflectivity.

26. A system for performing measurements on an optical network, the system comprising:
an optical service channel configured to transport control information over the optical network; and
a network management system coupled the optical service channel and configured to monitor the optical network for a fault, wherein location of the fault is determined by measuring distance to the fault using the optical channel.

27. The system according to claim 26, wherein the transport of the control information over the optical service channel is suspended upon detection of the fault, test signal being transmitted over the optical service channel.
